(19) United States
(12) Patent Application Publication
(10) Pub. No.: US 2006/0174683 A1
(43) Pub. Date: Aug. 10, 2006

(54) Functionalized field effect transistor sensor with self checking

(76) Inventors: Ulrich Bonne, Hopkins, MN (US); James F. Detry, Plymouth, MN (US); Richard A. Kirkpatrick II, Richardson, TX (US); Peter Tobias, Minnetonka, MN (US)

Correspondence Address: Kris T. Fredrick;Patent Services, Honeywell International Inc., 101 Columbia Road, Morristown, NJ, 07962, US

(21) Appl. No.: 11/241,591

(22) Filed: Sep. 30, 2005

Related U.S. Application Data
(63) Continuation-in-part of application No. 11/053,569, filed on Feb. 7, 2005.

(51) Int. Cl. G01N 35/00

(52) U.S. Cl. 73/1.02

(57) ABSTRACT

A self-calibration device and method for a FFET sensor having a thin functional film positioned to detect the presence of at least one specific component in a fluid, a current driven source, a gate and a voltage source applied to said gate, a tub and a drain. An input signal is applied to the gate to produce a measured output signal that is compared to an expected output reference signal. The input signal is selected from controlled voltage pulses to the gate, or the source bias current can be changed. Alternatively, the signal can be a known concentration pulse of the specific component applied to the FFET or a heat source pulse for changing the temperature of the FFET by a small amount.

This is a continuation-in-part of a commonly owned U.S. patent application having Ser. No. 11/053,569, filed Feb. 7, 2005, and incorporated herein by reference in its entirety.

### FIELD OF THE INVENTION

The present invention relates in general to functionalized field effect transducer (FFET). Sensors. More particularly, the present invention relates to a design and method for FFET self-calibrating sensors.

### BACKGROUND OF THE INVENTION

Multi-component exhaust gas sensors are needed to meet increasingly stringent government regulations. They are also needed for control of combustion performance and fuel economy, of indoor air quality, chemical processes and homeland security. There is also a need for sensors that operate in other fluid streams, such as smoke stacks and other discharge media. However, presently available exhaust gas sensors are costly, consume a lot of power, and/or are often limited to sensing one component. Sensors are available that sense O₂, NO, or NO₂, but are typically not able to sense gases like O, CO₂, or SO₂ nor self check their operation. In addition, their high power consumption does not allow self-powered operation.

Automatic or self-calibration is a need that has existed in the chemical process industry since the first process analyzers were introduced. The need to periodically calibrate analyzers and even small gas or liquid composition sensors is the result of the fact that age (internal diffusion of species, change in the micro-crystalline structure and migration of grain boundaries), environmental contamination or corrosion may change the original calibration. The response of the process industry has been to stop searching for the ideal zero-drift analyzers and build into the analyzer system the means to periodically expose them to calibration gasses. Since these systems were large and involved a large capital investment, this solution justified the relatively costly approach. For self-calibration of low cost sensors used in automobiles, residences and commercial buildings, lower cost approaches are needed.

In the above described co-pending patent application, such a sensor system is disclosed as having a sensor body positioned proximate a fluid medium being sensed. The body mounts a sensor for detecting the presence of at least one specific component and provides a signal representative of that presence. Preferred are sensors that detect a plurality of components in a medium. In exhaust gasses, for example, the sensor may detect O₂, CO, CO₂, NOₓ, NO, NO₂, SO₂, NH₃, CH₄, and other combustion products.

Gate-film aging, poisoning and/or corrosion can shift the current of FFETs, and thus it is desirable to find some method for avoiding uncertainties due to unpredictable changes in the FFET gate film. As a result, the FFETs described here and in the above referenced co-pending patent application, with unique, appropriate, tailored, and/or proprietary films on the FET gates need means to check that those films have not changed and cause erroneous output signals.

The sensor described in the above identified co-pending patent application may be a functionalized field effect transistor, a FFET, in which the gas analyte interacts with the gate material and changes its work function, Other sensors that detect the presence of a sought out component in a fluid medium are also contemplated in that application. When a FFET is used, this application suggests that the FFET may be self-calibrated by injecting a voltage pulse to the FET gate, to induce a known but short work-function shift, which would give rise to a pre-determined signal output change.

Accordingly it would be of great advantage in the sensor art if a FFET sensor could be provided that is self-calibrating.

Another advantage would be to provide a sensor that would include self-diagnostics.

Other advantages and features will appear hereinafter.

### SUMMARY OF THE INVENTION

The present invention provides a self-calibration method for FFETs in which the application of controlled charges or signals is made. The FFET device has a thin functional film positioned to receive a fluid and detect the presence of at least one specific component in the fluid. In the preferred embodiment the drain, gate and tub are each voltage driven, and the source is current driven.

A self-check signal source applies a signal to the gate to produce a measured signal. The measured signal upon reception thereof is compared to a reference signal stored in a storage unit to produce a self-check signal. Operability of the FFET is determined by comparing this self-check signal to predetermined limits.

The signal source may consist of:
1. Application of a controlled voltage to the gate, and the measured signal would then be the leakage current through the gate insulator to check the insulation resistance of the gate dielectric.
2. Application of a second contact on the gate connected to a voltage that is different than the applied gate voltage at the first contact so that the measured signal is current through the thin functional film on the gate to check the sheet resistance of the thin functional film. Or
3. A change in the source-current, and the measured signal is the observed gate voltage change. Or
4. Application of a signal source in the form of a reference gas having a known concentration of the specific component that is applied to the FFET, and the measured signal is the sensor signal thus produced. Or
5. A heat source for changing the temperature of the FFET by a small amount for a period of time so that the measured signal is the change in gate voltage.

A proximate FET may compensate for changes in ambient temperature; a proximate FFET with a different chemical makeup that the main or #1 FFET may compensate for other common but undesirable signals such as those generated by common changes in RH or ambient humidity.

### BRIEF DESCRIPTION OF THE DRAWINGS

For a more complete understanding of the invention, reference is hereby made to the drawings, in which:

FIG. 1 is a side elevational view in cross section a FFET for use with the present invention;

FIG. 2A is a plan view of one embodiment of the present invention;

FIG. 2B is a plan view of another embodiment of the present invention;

FIG. 3A is a block diagram of the calibration circuit used with the embodiment shown in FIG. 2A;

FIG. 3B is a block diagram of the calibration circuit used with the embodiment shown in FIG. 2B;

FIG. 4 is a block diagram of an alternate calibration circuit used with the present invention;

FIG. 5 is a block diagram of the preferred embodiment of the present invention;

FIG. 6 is a graph illustrating drain current;

FIG. 7 is a graph illustrating threshold voltage changes; and

FIG. 8 is a graph illustrating gain changes in the device of this invention.

### DETAILED DESCRIPTION OF THE PREFERRED EMBODIMENT

The present invention is a self check device and method for use with a FFET sensor system for detecting the presence of at least one specific component in a fluid medium such as, for example, an exhaust gas. In it's simplest form, the present invention comprises the application of a signal to the FFET gate to produce a measured signal. That measured signal is compared to a stored reference signal to produce a self check signal that is indicative of the difference between the measured signal and the reference signal. If the difference is outside an acceptable limit, as determined by the specific fluid medium, specific component and FFET, then the sensor is found to be inoperative and will be replaced or repaired.

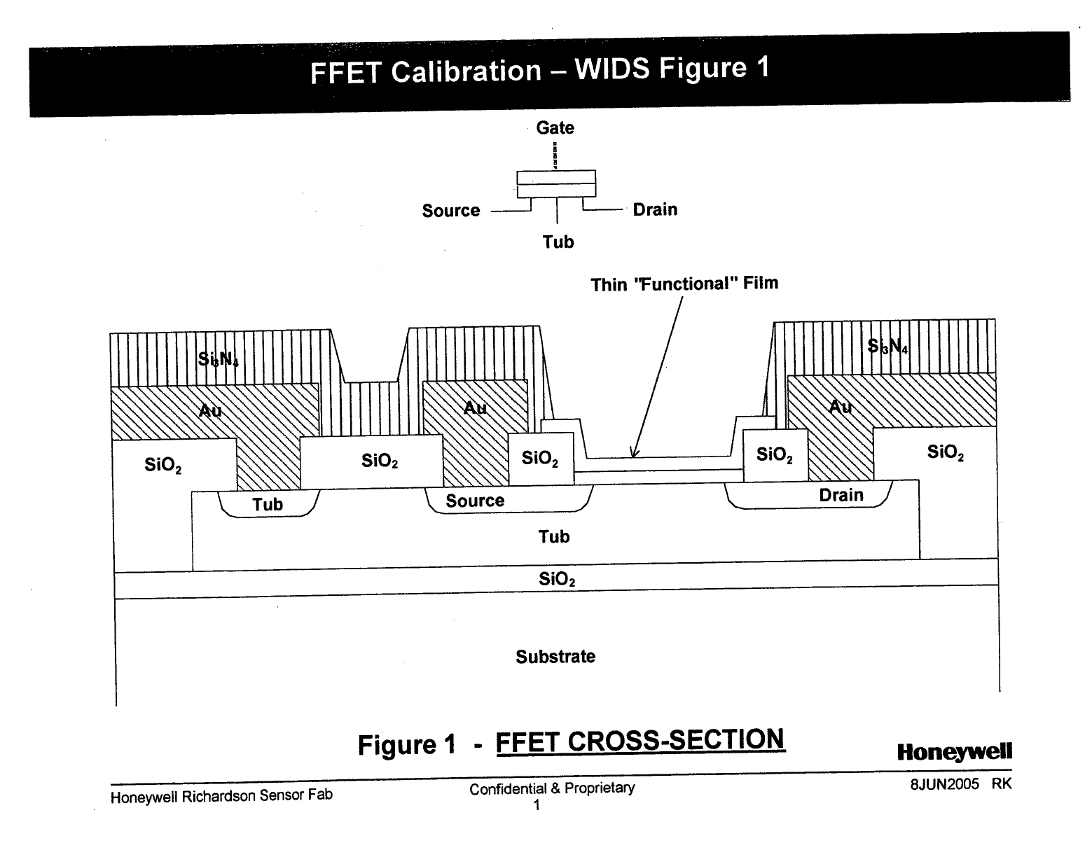

FIG. 1 illustrates a cross section of a FFET 10 generally of the type used as a sensor in commonly owned U.S. patent application having Ser. No. 11/053,569, filed Feb. 7, 2005, the disclosure of which has been above incorporated herein by reference in its entirety. There would be one such FFET for each analyte, but several such FFETs could form a monolithic mosaic-like cluster on one chip. Alternatively, several chips could be mounted close together to utilize the same power source and transmitter. The main distinction among the different FFETs may be the different materials serving to differentiate and make each FFET in the cluster selectively sensitive to one of the target analytes.

The device in FIG. 1 includes a current driven source, a gate, and a voltage source that is applied to the gate as described below. Such a sensor is mounted in the sensor body for detecting the presence of at least one specific component in the fluid and providing a signal representative of its presence. Preferred are sensors that detect a plurality of components in a medium. In exhaust gasses, for example, the sensor may detect O₂, CO, CO₂, NOₓ, NO, NO₂, SO₂, NH₃, CH₄, and other combustion products. Also contemplated are sensors that detect the group of alkenes or even larger groups of organic materials. Table I below illustrates some of the possible configurations of the FFET that would be self checked by the present invention.

TABLE I

| Analyte | Film | Reversible Reaction Product |
|---|---|---|
| CO | Fe | Fe(CO)₅ |
| CO | Ni | Ni(CO)₅ |
| CO₂ | CaO | CaCO₃ |
| CO₂ | NaO | NaCO₃ |
| H₂ | Pd/Ni | Pd/Ni.H₂ |
| O₂ | | |
| NH₃ | CoCl₁₂ | Co(NH₃)₆Cl₁₂ |
| NH₃ | FeCl₁₃ | Fe(NH₃)₆Cl₁₃ |
| NH₃ | NiCl₁₂ | Ni(NH₃)₆Cl₁₂ |
| NO | | |
| NO₂ | | |
| SO₂ | | |
| HO₂ | | |

There would be one such FFET for each analyte, but several such FFETs could form a monolithic mosaic-like cluster on one chip. Alternatively, several chips could be mounted close together to utilize the same power source and transmitter.

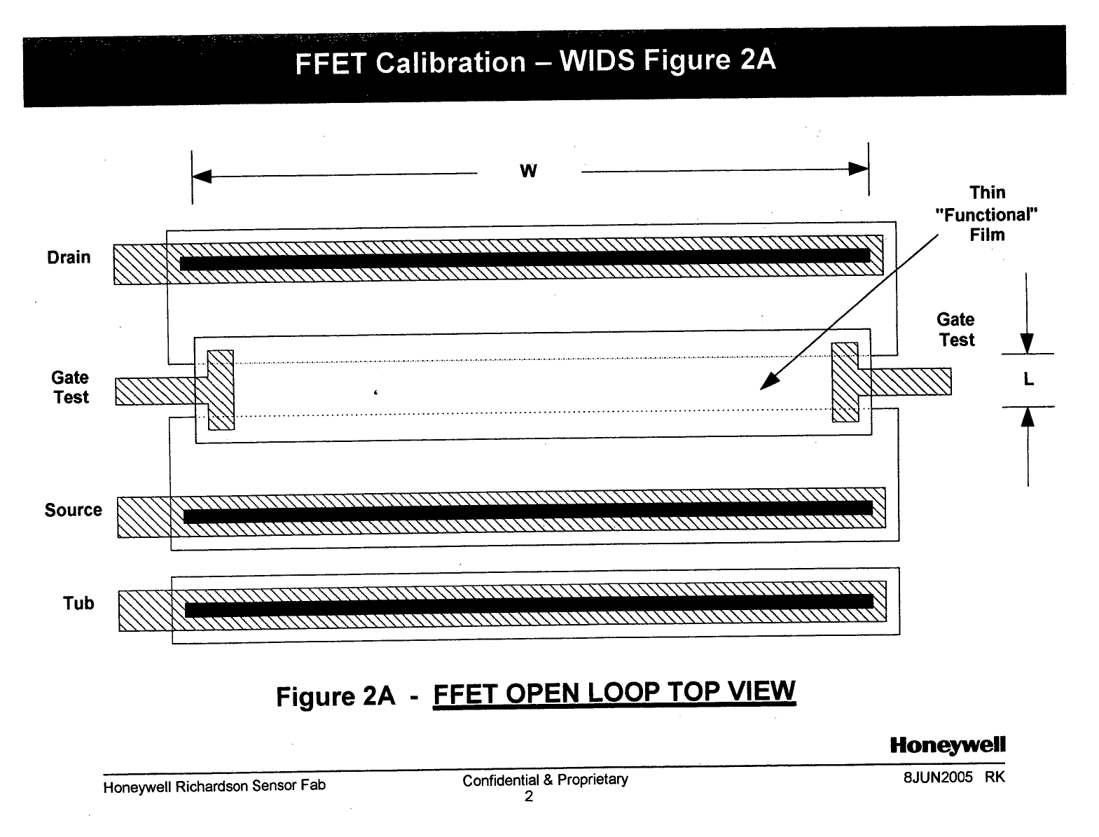

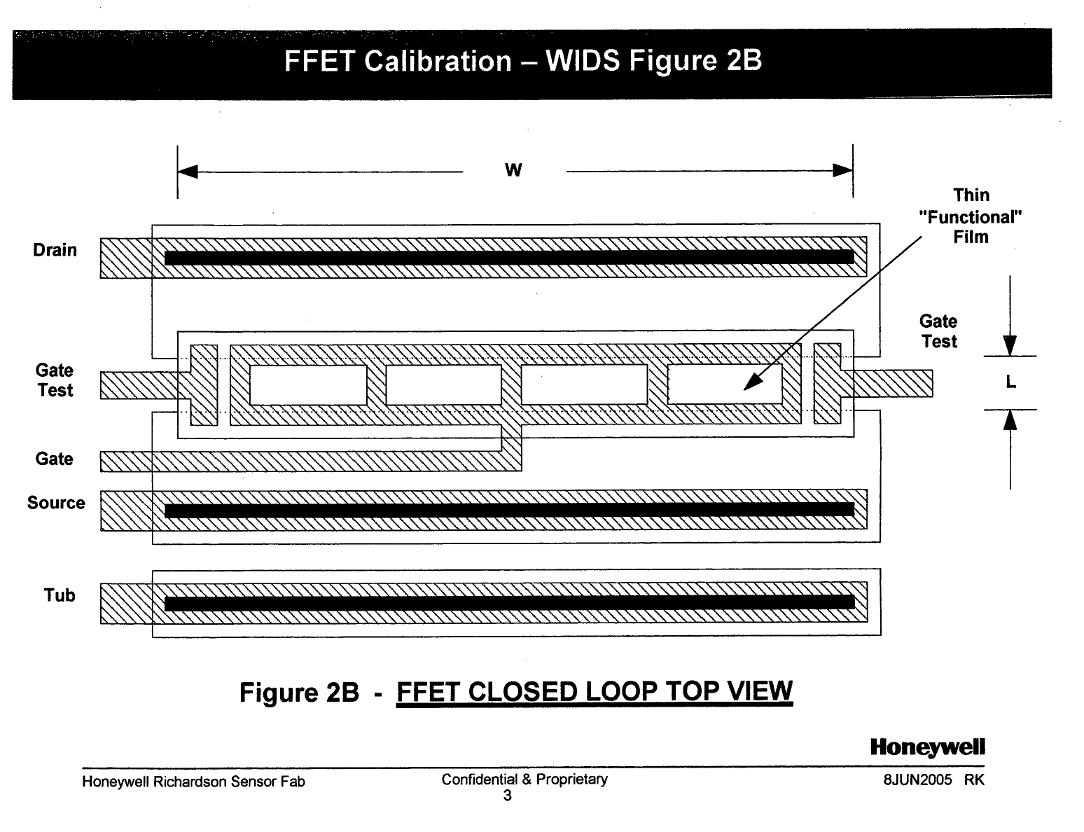

FIG. 2A illustrates the top or plan view of the open loop FFET, where gate test strips are provided at both ends of the FFET thin functional film to allow electrical control of the FFET during self check as well as open thin functional film for chemical control during application sensing. FIG. 2B represents the closed loop version of a FFET. A gate terminal is added to provide electrical control of the gate. Note that there is still a sufficient amount of open thin functional film for chemical sensing. In an open loop configuration, there is no direct electrical control of the gate, but only chemical control, such as when an analyte is detected. In a closed loop configuration, both chemical and direct electrical control are utilized.

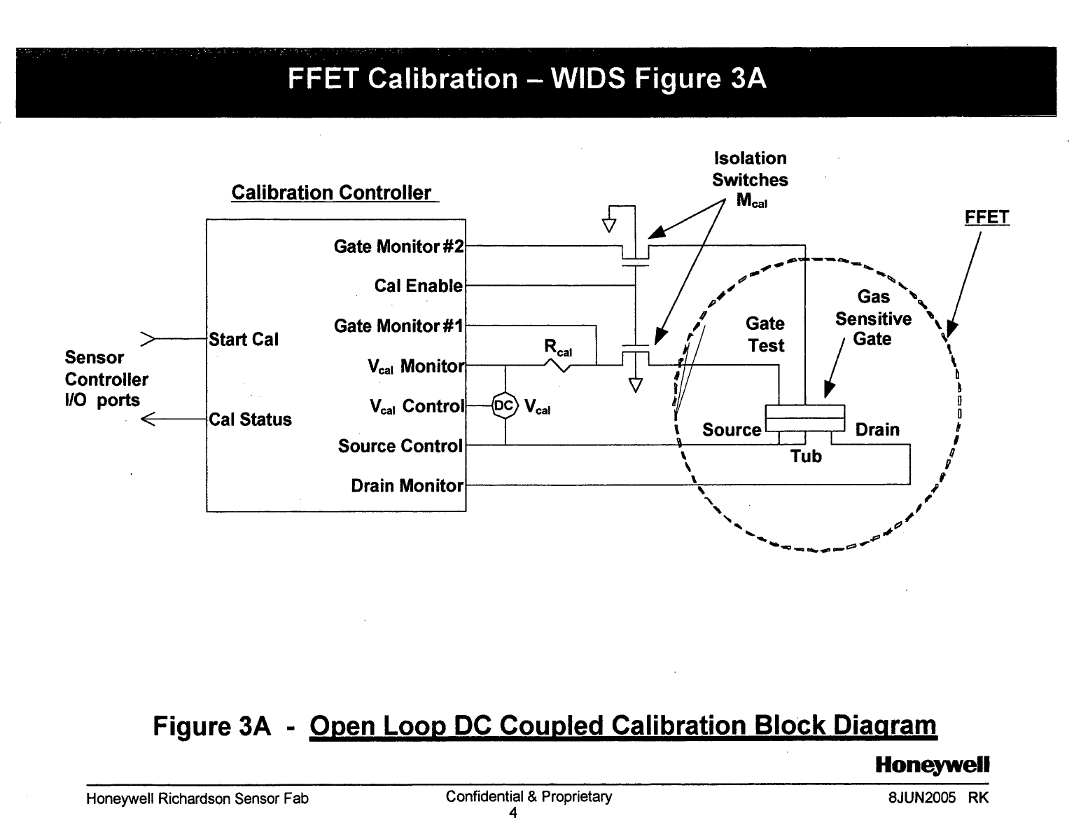

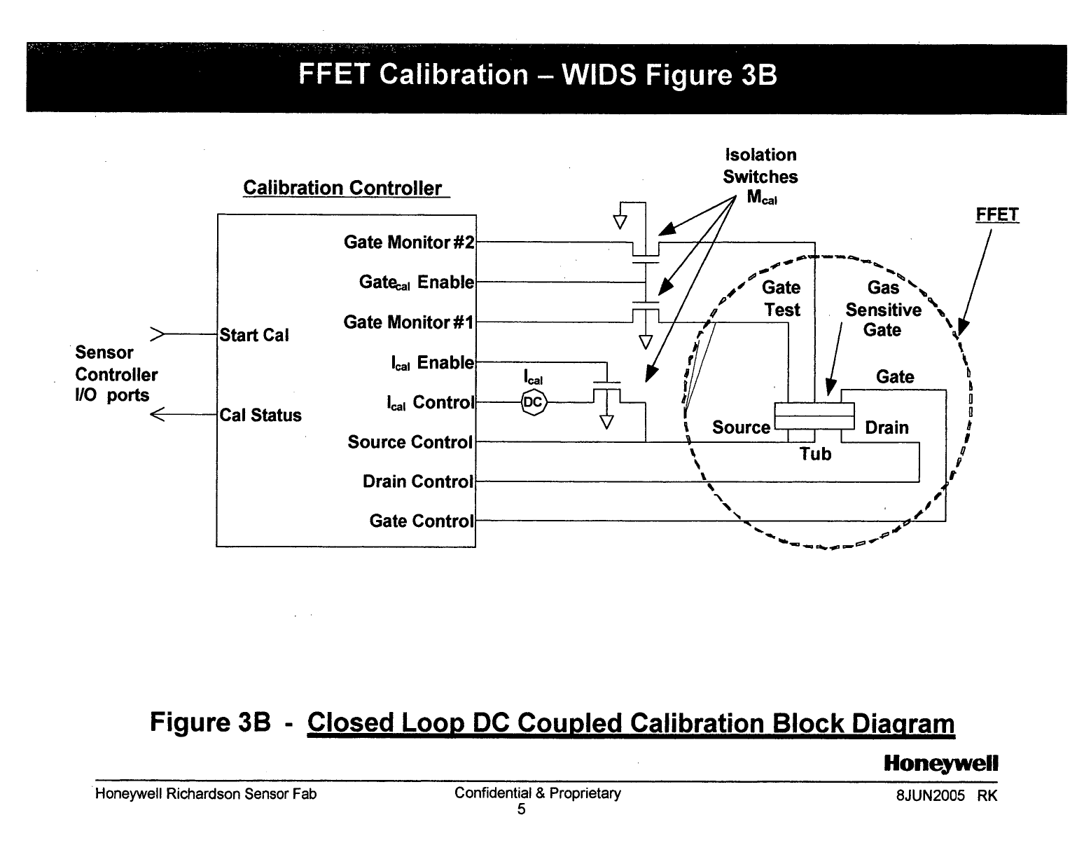

FIG. 3A is for an open loop DC coupled system. The isolation switches are normally off (i.e. open) when the device functions as a sensor. To self check or test the device, the isolation switches are turned on (i.e. closed). If one changes the voltage seen by the thin functional film or gas sensitive gate in FIG. 3A, by closing the lower isolation switch to allow a voltage, Vcal, to reach the test gate, then the voltage drop between gate monitor #1 and the source and current through Rcal provides a self check of the gate insulation resistance. Closing the upper isolation switch allows the current through Rcal to flow through the gas sensitive thin film on the gate. The voltage drop between gate monitor #1 and gate monitor #2 and the current through Rcal provides a self check of the sheet resistance of the thin film.

FIG. 3B is a closed loop version of the DC coupled system. In FIG. 3B the same gate resistance tests may be performed (note that Vcal and Rcal are not shown) as described in the above paragraph. Additionally, a source control is used to supply a bias current for the FFET. If the lower isolation switch is closed, then a current, Ical, is added to that that source control to modify the bias current through the FFET. The change in the voltage drop between the gate and source provides a self check of the electrical functionality of the FFET.

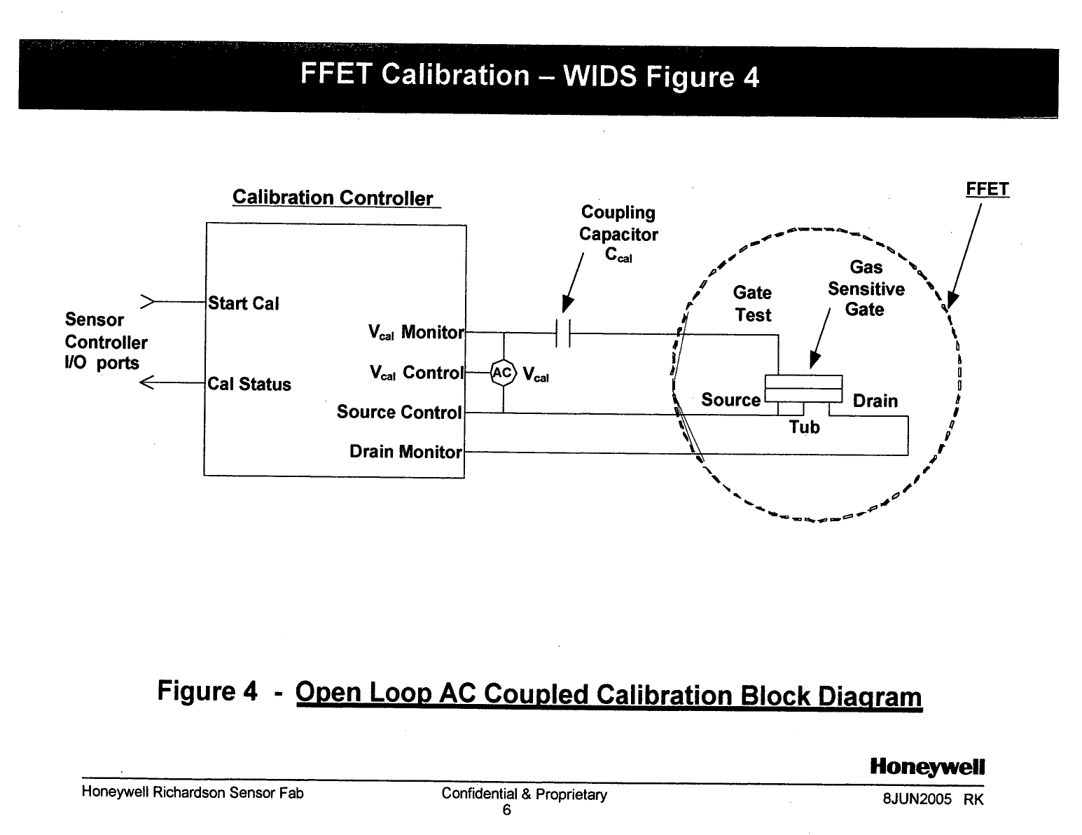

FIG. 4 illustrates an open loop AC control which can be used when the isolation switches of FIGS. 3A and 3B aren't capable of fully isolating the test components. In FIG. 4, an AC voltage, Vcal is coupled to the gate through capacitor, Ccal. The perturbation in the drain current gives information about the electrical functionality of the FFET.

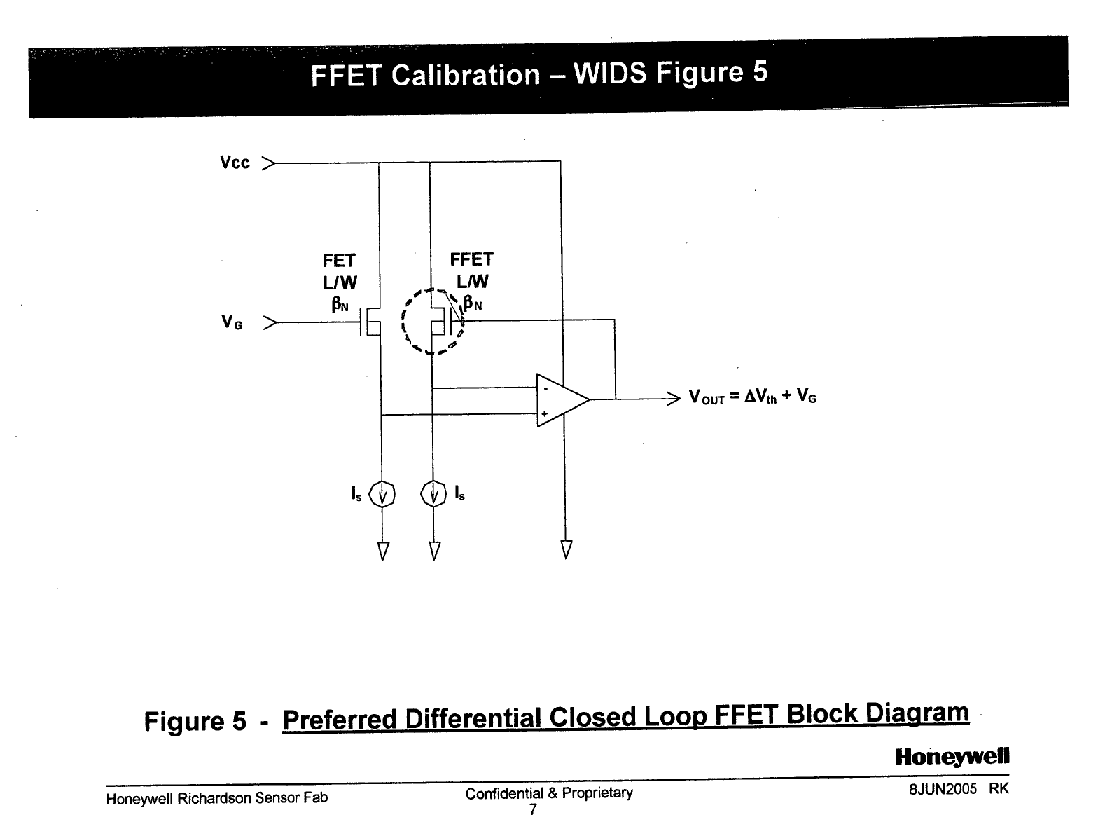

FIG. 5 represents a preferred way to accomplish closed loop operation to derive a test result. FETs and FFETs are not perfectly uniform and may be sensitive to a number of factors when made from different batch sources or at different times. In FIG. 5, the FFET of the invention is provided with a FET on the same chip and in close proximity to the FFET, for the purpose of having a close relationship of the chemical and electrical characteristics of the two. The circuit shown in FIG. 5 provides the voltage out as being the voltage at the gate plus an additional voltage difference. This voltage difference is measured by comparing the voltage of both the FFET and the FET.

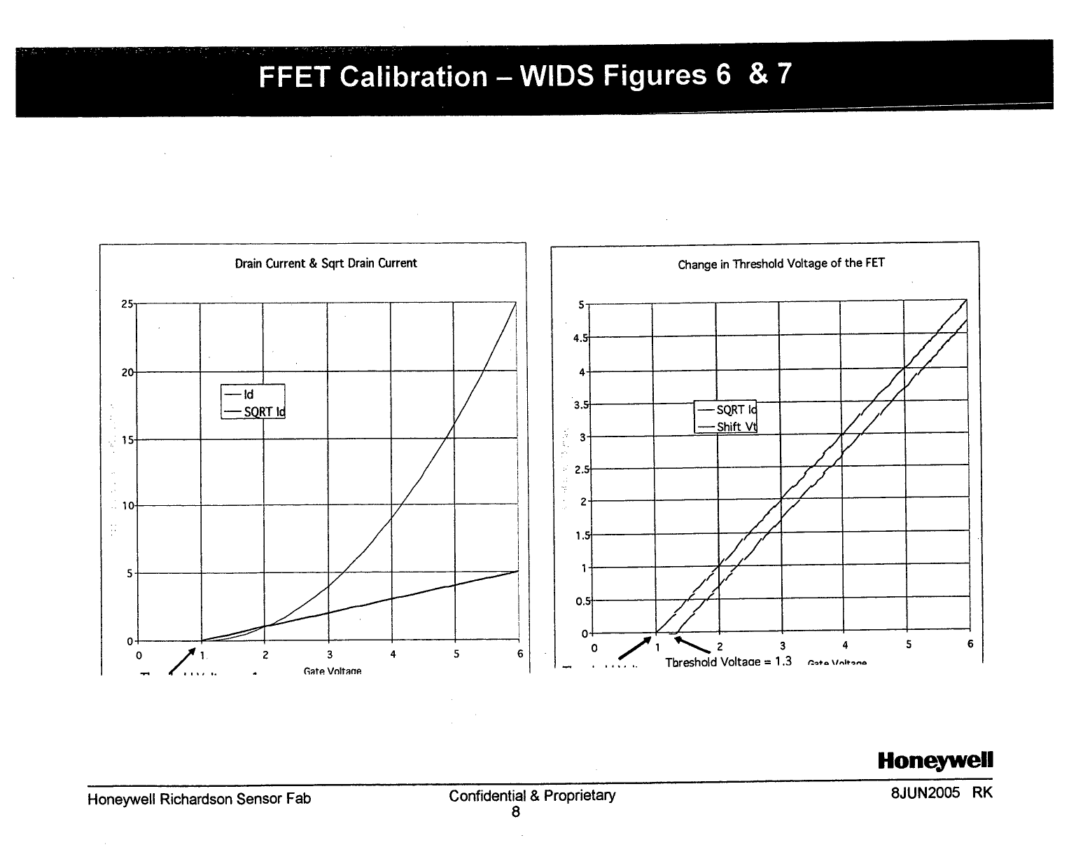

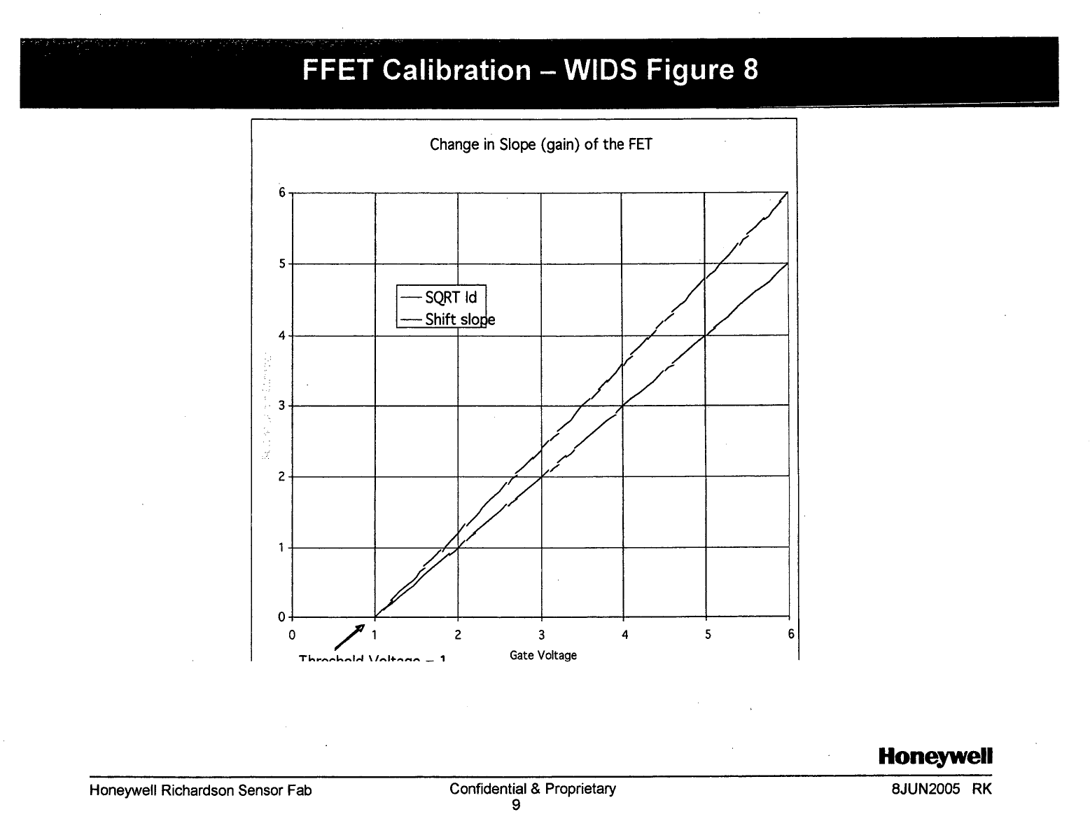

FIG. 6 illustrates that the drain current compared to the gate to source voltage drop is linear when the square root of the current is plotted under the condition that the channel length is sufficiently long. This is the data of interest in the self checks for electrical functionality of the FFET. In FIG. 7, small changes are noted in a FFET after some period of use, particularly in the threshold voltage. Monitoring this will predict or demonstrate a failed FFET. Finally, FIG. 8 illustrates the result of a change in the gain of the FFET. The shift in slope (gain) is an indication of change in the chemical properties of the thin functional film or in the volume of gate material that may change during use. This data, along with the preceding self check tests shows the basic underlying health of the FFET device.

The FFET, alone or with a reference FET as shown in FIG. 5, is normally operated in a current source mode. In one embodiment, the current source mode is switched off, controlled voltages are applied to the gate, preferably with the semiconductor in accumulation, and the leakage currents through the insulator are measured. A self-check can be performed in both simple and in more complicated modes. In the simple mode, a single voltage is applied and the current is measured. In the complicated modes, many currents are measured, either over time for a single voltage, or even for different voltages, e.g. in a sweep like in cyclic voltammetry. The leakage current measurements of the FFET are compared with its stored reference values and additionally with the same type of measurements of the reference FET. If they deviate too much, the FFET is considered to be broken. After the self-check, the current source mode is switched on again, and the gate voltage is evaluated again as the sensor signal after a characteristic relaxation time.

For another self-check, the current source mode is switched off, controlled voltages are applied to the gate and the second contact on the gate is no longer left floating but is connected to a voltage different than the applied gate voltage at the first contact. The range of measurement complexity is described in the previous paragraph. The current through the thin film on the gate is measured and compared with its stored reference values. If they deviate too much, the FFET is considered to be broken. After this self-check, the current source mode is switched on again, and the gate voltage is evaluated again as the sensor signal after a characteristic relaxation time.

Another self-check can be made that should not be performed during the relaxation from the first two described self-checks. For this self-check, the current source mode remains on, but the gate voltage is not evaluated as the sensor signal. The source bias-current is modified and the drain current and gate to source voltage is measured so that the threshold voltage and gain of the FFET may be analyzed with a range of measurement complexity as described in the previous paragraph. The threshold voltage and main measurements of the FFET are compared with its stored reference values and additionally with the same type of measurements of the reference FET. If they deviate too much, the FFET is considered to be broken. After this self check the source bias current is restored to its starting value and the gate is evaluated again as the sensor signal after a characteristic relaxation time.

For yet another self-check, the current source mode remains on, and a reference gas that is available or automatically generated nearby is led over the FFET. The sensor signal is compared with stored reference values during this type of gas exposure for detection of a baseline drift, and the subsequent sensor signals during normal gas exposure are evaluated including any baseline drift.

While particular embodiments of the present invention have been illustrated and described, they are merely exemplary and a person skilled in the art may make variations and modifications to the embodiments described herein without departing from the spirit and scope of the present invention. All such equivalent variations and modifications are intended to be included within the scope of this invention, and it is not intended to limit the invention, except as defined by the following claims.

1. In a FFET sensor having a thin functional film positioned to contact a fluid and detect the presence of at least one specific component in said fluid, a current driven source, a gate and a voltage source applied to said gate, a tub and a drain, the improvement comprising:
a signal source for applying an input signal to said FFET to produce an output signal;
a storage unit for storing reference signals; and
a comparator for comparing the output signal upon application thereof to a reference output signal to produce a self-check signal indicative of the difference between said output signal and said reference output signal against a predetermined value for operability of said FFET.

2. The sensor of claim 1, wherein said signal source is adapted to apply controlled voltages to the gate and said output signal is leakage current through the gate insulator.

3. The sensor of claim 1, wherein said signal source includes a second contact on the gate connected to a voltage that is different than the applied gate voltage at the first contact and said measured signal is current through the thin functional film on the gate.

4. The sensor of claim 1, wherein said signal source is a source bias current change, and said output signal is the observed gate to source voltage drop change.

5. The sensor of claim 1, wherein said signal source is a pulse of reference gas having a known concentration of said specific component is applied to the FFET and the output signal is the sensor signal thus produced.

6. The sensor of claim 1, wherein said signal source is a temperature source pulse for changing the temperature of the FFET by a small amount and the output signal is the change in gate voltage.

7. The sensor of claim 1, which further includes a FET formed on the same substrate as said FFET and proximate to said FFET and said signal source is adapted to apply the same signal to said FET.

8. In a FFET sensor having a thin film functional film positioned to contact a fluid and detect the presence of at least one specific component in said fluid, a current driven source, a gate and a voltage source applied to said gate, a tub and a drain, the improvement comprising:
signal source means for applying an input signal to said FFET gate to produce an output signal;
storage unit means for storing reference signals; and
comparator means for comparing the output signal upon application thereof to an output reference signal to produce a self-check signal indicative of the difference between said output signal and said output reference signal against a predetermined value for operability of said FFET.

9. The sensor of claim 8, wherein said signal source means is adapted to apply controlled voltages to the gate and said measured signal is leakage current through the gate insulator.

10. The sensor of claim 8, wherein said signal source includes a second contact on the gate connected to a voltage that is different than the applied gate voltage at the first contact and said output signal is current through the thin functional film on the gate.

11. The sensor of claim 8, wherein said source bias current is changed, and said output signal is the observed gate to source voltage drop change.

12. The sensor of claim 8, wherein said signal source is a pulse of reference gas having a known concentration of said specific component is applied to the FFET and the measured signal is the sensor signal thus produced.

13. The sensor of claim 8, wherein said signal source is a temperature source pulse for changing the temperature of the FFET by a small amount and the measured signal is the change in gate voltage.

14. The sensor of claim 8, which further includes a FET formed on the same substrate as said FFET and proximate to said FFET and said signal source means is adapted to apply the same signal to said FET.

15. A method of self checking the operation of a FFET sensor having a thin functional film positioned to contact a fluid and detect the presence of at least one specific component in said fluid, a current driven source, a gate and a voltage source applied to said gate, a tub and a drain, comprising the steps of:
applying an input signal from a signal source to said gate to produce a output signal;
comparing the output signal upon application thereof to an output reference signal stored in a storage unit to produce a self-check signal indicative of the difference between said output signal and said output reference signal against a predetermined value for operability of said FFET.

16. The method of claim 15, wherein said signal source applies an input signal of controlled voltages to the gate and said output signal is measured as leakage current through the gate insulator.

17. The method of claim 15, wherein said signal source includes a second contact on the gate and applies a voltage that is different than the applied gate voltage at the first contact and said output signal is measured as current through the thin functional film on the gate.

18. The method of claim 15, wherein said source bias signal is changed constant-current, and said output signal is measured as the observed gate to source voltage drop change.

19. The method of claim 15, wherein a pulse of reference gas having a known concentration of said specific component is applied to the FFET and the measured signal is measured as the sensor signal thus produced.

20. The method of claim 15, wherein said signal source is applied as a temperature source pulse changing the temperature of the FFET by a small amount and the measured signal is measured as the change in gate voltage.

21. The method of claim 18, which further includes providing a FET formed on the same substrate as said FFET and proximate to said FFET and said signal is passed through both said FFET and said FET for comparison.
